(19) United States
(12) Patent Application Publication
(10) Pub. No.: US 2016/0346972 A1
(43) Pub. Date: Dec. 1, 2016

(54) INJECTION MOLDED GOLF BALL LAYER WITH IMPROVED DURABILITY & METHODS OF MAKING SAME

(71) Applicant: Acushnet Company, Fairhaven, MA (US)

(72) Inventor: Mark L. Binette, Mattapoisett, MA (US)

(73) Assignee: Acushnet Company, Fairhaven, MA (US)

(21) Appl. No.: 14/721,387

(22) Filed: May 26, 2015

(51) Int. Cl. B29C 45/14

(52) U.S. Cl. CPC B29C 45/14065; B29C 45/14008; B29K 2075/02

(57) ABSTRACT

The present invention is directed to a golf ball layer formed from an injection molding process using a retractable pin injection mold. The injection molding process includes retracting pins beyond the molding surface of the mold at the end of the injection cycle to form surface protrusions at the various pin locations and removing the protrusions in a post molding process. The injection molding process of the present invention results in golf ball layers having reduced molded in stresses and defects and enhanced durability.

### FIELD OF THE INVENTION

The present invention relates to golf balls, and more specifically, to golf ball cover layers exhibiting improved impact durability. In particular, the present invention relates to improved retractable pin injection molding processes that produce golf ball layers having reduced molded stresses and defects and better impact durability.

### BACKGROUND OF THE INVENTION

Conventionally, golf balls are made by molding a cover around a core. The cover may be injection molded, compression molded, or cast over the core. Casting is the most common method of producing a urethane or urea layer on a golf ball. However, the materials typically used in casting require a relatively long gel time. In turn, long gel times have the disadvantage of requiring long cure times for the material to set before the ball can be de-molded or removed from the mold. Additionally, once de-molded, cast golf balls usually require subsequent buffing and other finishing process steps. Further, one or more material properties, e.g., flexural modulus or resiliency, may be sacrificed or, at a minimum, non-optimal, when using materials with a long gel time.

Manufacturers have experimented with injection molding, particularly retractable pin injection molding, as a method to produce cover layers on a golf ball. The conventional injection molding process requires that the mold include retractable positioning pins to hold the inner ball in the spherical center of the mold cavity. More specifically, once the core is positioned in the first mold cavity half, the second mold cavity half is mated to the first so that the mold may be closed. A cover material is then injected into the closed mold. The positioning pins are then retracted flush with the mold while the cover material is still flowable to allow the cover material to fill in any holes caused by the pins in the underlying inner ball. When the cover material is at least partially cured, the covered ball is removed from the mold.

However, the conventional retractable pin injection molding process is subject to technical challenges. In particular, golf ball layers formed via this process are likely to demonstrate durability issues. For example, when the molten cover material contacts the cool retractable pins, the cover material cools prematurely and creates fragile knit lines at or around the individual pins. Intermediate or cover layers are inherently weaker along the knit lines and in turn, suffer a reduction in impact durability along these knit lines. In addition, air and gas from the molding process often try to escape through the venting provided around the pins, and then become trapped in the pin area. This creates voids and pin holes in the golf ball cover layer which weaken the cover layer and reduce durability.

Accordingly, there remains a need for an improved retractable pin injection molding process that produces golf ball layers having reduced molded stresses and defects and better overall impact durability.

### SUMMARY OF THE INVENTION

The present invention is directed to a method of forming a golf ball, including: providing a mold cavity including a first mold half having a first cavity half defining a first hemispherical portion having a first wall and a second mold half including a second cavity half defining a second hemispherical portion having a second wall; placing an inner ball having an outer surface into the first mold half; extending retractable pins into the first mold half to retain the inner ball within the first mold half; mating the second mold half to the first mold half; extending retractable pins into the second mold half, wherein the distance from the outer surface to the first wall is substantially the same as the distance from the outer surface to the second wall; injecting a material into the mold cavity to form a layer disposed about the inner ball; withdrawing the retractable pins beyond the first and second walls to allow the material to flow into recesses formed between the withdrawn pins and the first and second walls and form protrusions at each of the recesses; cooling the material; and removing the protrusions to form a golf ball.

In this aspect of the invention, the first and second mold halves each include at least three retractable pins. In another embodiment, the step of removing the protrusions includes cutting, grinding, abrasion, centerless grinding, abrasive tumbling, sanding, heating, or combinations thereof. In still another embodiment, the material includes an ionomer, a polyamide, a polyurethane, a polyurea, or combinations thereof. In this aspect, the ionomer may have a hardness of about 60 to about 75 Shore D. In yet another embodiment, the retractable pins are withdrawn a distance of at least about 25 percent of the thickness of the golf ball layer.

The present invention is also directed to a method of forming a golf ball, including: providing a mold including an upper mold plate, a lower mold plate, wherein the upper and lower mold plate each include at least three retractable pins, and wherein the upper and lower mold plates mate to form a mold cavity having a substantially spherical cavity wall; placing an inner ball into the mold cavity; extending the at least three retractable pins into the mold cavity in each of the upper and lower mold plates to hold the inner ball within the mold cavity, wherein the retractable pins produce a space between the cavity wall and the outer surface of the inner ball; injecting a material into the mold cavity to form a golf ball layer disposed about the inner ball; withdrawing the retractable pins beyond the cavity wall a predetermined distance to allow the material to flow into recesses formed between the withdrawn pins and the cavity wall and form protrusions at each of the recesses; cooling the material to form a provisional golf ball having a plurality of protrusions; de-molding the provisional golf ball; and removing the protrusions to form a golf ball.

In this aspect of the invention, the step of removing the protrusions further includes cutting, grinding, abrasion, centerless grinding, abrasive tumbling, sanding, heating, and combinations thereof. In another embodiment, the step of withdrawing the retractable pins includes withdrawing the retractable pins a predetermined distance that is at least about 25 percent of the thickness of the golf ball layer. In still another embodiment, the method may further include surface treating the golf ball. For example, the step of surface treating includes mechanical abrasion; plasma treatment; corona treatment; flame treatment; wet chemical surface modification; application of adhesives or adhesion promoters; and combinations thereof.

The present invention is further directed to a method for injection molding a golf ball layer about an inner ball, including: providing a mold including an upper mold plate and a lower mold plate, wherein the upper and lower mold plates each include at least three retractable pins for holding the inner ball within a cavity formed by mating the upper and lower mold plates, wherein the cavity has a substantially spherical surface; placing the inner ball into the mold, wherein the inner ball has an outer surface; extending the retractable pins into the cavity to form a space between the cavity surface and the outer surface of the inner ball; injecting a layer-forming material into the cavity to fill the space and form a golf ball layer disposed about the inner ball; withdrawing the retractable pins beyond the cavity surface a distance of at least about 25 percent of the thickness of the golf ball layer to allow the material to flow into recesses formed between the withdrawn pins and the cavity surface and form protrusions at each of the recesses; cooling the layer-forming material to form a provisional golf ball having a plurality of protrusions; de-molding the provisional golf ball; and removing the protrusions to form a golf ball.

In one embodiment, the step of withdrawing the retractable pins is performed at a distance at least 50 percent of the thickness of the golf ball layer. For example, the distance is at least 100 percent of the thickness of the golf ball layer. In another embodiment, the step of removing the protrusions further includes cutting, grinding, abrasion, centerless grinding, abrasive tumbling, sanding, heating, and combinations thereof. In yet another embodiment, the method further includes molding one or more additional layers over the golf ball.

### BRIEF DESCRIPTION OF THE DRAWINGS

Further features and advantages of the invention can be ascertained from the following detailed description that is provided in connection with the drawing(s) described below:

FIG. 1 illustrates a cross-sectional view of a retractable pin injection molding device contemplated by the present invention;

FIG. 2 illustrates a flow chart for the steps of a method of using the retractable pin injection molding device of FIG. 1;

FIG. 3 illustrates a cross-sectional view of the retractable pin injection molding device during one embodiment of the present invention; and

FIG. 4 illustrates a resulting product according to one embodiment of the present invention.

### DETAILED DESCRIPTION OF THE INVENTION

The present invention is directed to golf balls formed with at least one layer formed from an injection molding process using a retractable pin injection mold (“RPIM”). The present invention also relates to the RPIM and the various embodiments of the method using the mold to produce the resulting golf ball.

In one embodiment, the injection molding process of the invention includes retracting the pins beyond the molding surface of the mold at the end of the injection cycle to form surface protrusions at the various pin locations. In such an embodiment, the protrusions are removed in a post molding process.

The injection molding process of the present invention results in golf balls having reduced molded-in stresses and defects. As a result, the molded golf ball has enhanced durability.

### The RPIM Mold

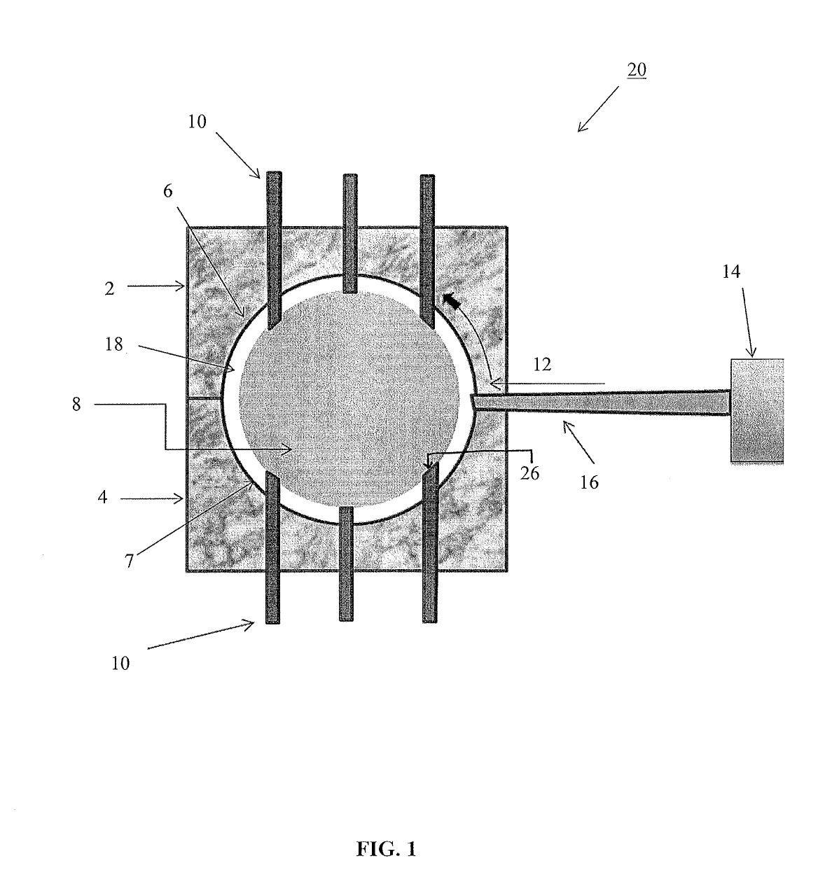

The present invention contemplates the use of a RPIM mold to form an outer layer of a golf ball. While any RPIM mold known to one of ordinary skill in the art may be used with the present invention, FIG. 1 illustrates a specific embodiment of a RPIM mold suitable for use with the present invention.

In particular, the RPIM mold includes opposing mold components defined by two mold cavity halves that cooperate to form a mold. The mold components may be arranged in a variety of orientations; however, the horizontal orientation is a preferred orientation. In one embodiment, as shown in FIG. 1, the RPIM mold 20 includes at least one upper mold plate 2 and at least one lower mold plate 4. Each mold plate has a hemispherical cavity formed therein. The cavities of the upper and lower mold plates 2 and 4 mate to form a spherical mold cavity 6. The mold cavity 6 has a spherical outer wall 7. The mating surfaces of the corresponding mold plates 2 and 4 may be planar, non-planar, or offset from the equator of the ball to be formed. The mold cavity surface may be smooth or textured according to the desired texture of the surface of the ball layer formed. For example, in one embodiment, the mold cavity surface includes protrusions. More specifically, when forming a cover layer, for instance, it is preferred that the mold cavity surface is textured with a plurality of projections that form a plurality of dimples in the finished golf ball cover.

Before the mold plates 2 and 4 are joined to close the mold 20, a substantially spherical golf ball product 8 is placed into the mold. The golf ball product 8 is positioned within the mold cavity 6 formed by closing mold plates 2 and 4 so that the golf ball product 8 is essentially evenly spaced apart from the outer wall 7 so that a cover layer or intermediate layer may be formed with a substantially consistent thickness in the empty layer of space 18 over the inner ball 8.

The inner ball 8 may be a component at any stage of manufacturing. The present invention contemplates two-piece, three-piece and multi-piece golf balls. Thus, in one embodiment, the inner ball 8 is a core. In another embodiment, the inner ball 8 is a core with one or more intermediate layers or inner cover layers formed thereon. As such, any references to inner ball 8 are intended to represent any golf ball component prior to adding an additional outer layer thereon. In one embodiment, the layer added to the inner ball 8 is the outermost cover layer; however, in another embodiment, the layer added to the inner ball 8 is not the outermost cover layer.

To maintain the position of the inner ball 8 in the mold cavity 6 before and during injection of material that will form the outer layer disposed thereon, the inner ball 8 is supported within the mold cavity 6 by a plurality of retractable pins 10. As shown in FIG. 1, the retractable pins 10 extend from the outer wall 7 of the mold cavity 6 to the outer surface of the inner ball 8 such that space 18 may be ultimately filled with a layer-forming material. The pins 10 hold the inner ball 8 within the mold cavity 6 such that the injected material will be substantially evenly disposed about the inner ball 8. When extended, each retractable pin 10 travels in a direction approximately radially inward toward the center of the inner ball 8.

The number and arrangement of retractable pins may vary according to the type of layer being applied. For example, when the layer being added in an outermost cover layer, the number and arrangement of retractable pins may vary according to the dimple pattern and/or dimple size(s). In one embodiment, as shown in FIG. 1, the mold includes at least three retractable pins 10 per mold plate 2 and 4. The retractable pins 10 of the upper mold plate 2 extend from the upper mold plate 2 downward into the cavity 6. The retractable pins 10 of the lower mold plate 4 extend from the lower mold plate 4 upward into the cavity 6. In this aspect, the pins may be oriented in the direction of material flow 12. The mold may optionally include non-moving vent pins.

In another embodiment, the mold may include two sets of retractable pins per mold plate, e.g., two sets of three retractable pins per mold plate. In this aspect, a first set of retractable pins supports the inner ball 8 during injection, while a second set of retractable pins retracts beyond the mold surface. In this aspect, the second set of pins is positioned adjacent to the first set of support pins but closer to the pole axis. The pins should also be oriented in the direction of material flow so that cold material formed when contacting the support pins can fill into the recessed areas left by the retracted vent pins.

While the present invention permits retractable pins 10 to be positioned nearly anywhere in the golf ball mold 20, one embodiment contemplates that the retractable pins 10 contact the surface of the inner ball 8 at a point that is between about 10 degrees to about 80 degrees from the pole-to-pole axis of the golf ball mold 20, more preferably between about 30 degrees to about 60 degrees, and most preferably at about 45 degrees.

When disengaged from the inner ball 8, the retractable pins 10 are withdrawn from the mold cavity 6. In this aspect, each retractable pin 10 travels in a direction approximately radially outward from the center of the inner ball 8. Each retractable pin has a face 26 that comes into contact with the mold cavity 6. The faces of the retractable pins 26 may be shaped to conform to the mold cavity 6. For instance, the pin faces may be shaped to form dimples on the golf ball cover, have a flat face, or a radius cut to match the curvature of the mold cavity.

The retractable pins 10 may be activated to engage with the inner ball 8 in any suitable manner known to one of ordinary skill in the art. For example, the retractable pins 10 may be spring loaded to assist in retraction of the pins 10 from the mold cavity 6. In another embodiment, the retractable pins 10 may be activated by plates that control movement of the pins 10 to engage with the core 8. The plates may be activated in a variety of manners known within the art including hydraulically and pneumatically.

After the pins 10 have engaged with the inner ball 8, a heated material is injected into the mold cavity 6. Reservoirs 14, such as tanks, house the layer-forming material, which is discussed in more detail below. The reservoirs are connected to pathways 16 in which the layer-forming material flows into the mold cavity 6. In one embodiment, as shown in FIG. 1, the injected material enters at or near the parting line of the mold cavity 6 and travels toward the poles of the golf ball mold 20. In another embodiment, the injected material enters the mold cavity 6 near the poles and travels toward the parting line of the golf ball mold 20. Once the mold cavity 6 is filled, the layer-forming material is allowed to cool.

### Layer-Forming Materials

The layer-forming materials that may be used with the present invention include any type of polymeric material that is hard and impact-sensitive. Suitable layer-forming materials include, but are not limited to, partially or fully neutralized ionomers; bimodal ionomers, such as Surlyn® AD 1043, 1092, and 1022 ionomer resins, commercially available from E. I. du Pont de Nemours and Company; ionomers modified with rosins; polyolefins; polyamides; polyesters; polyethers; polycarbonates; polysulfones; polyacetals; polylactones; acrylonitrile-butadiene-styrene resins; polyphenylene oxide; polyphenylene sulfide; styrene-acrylonitrile resins; styrene maleic anhydride; polyimides; aromatic polyketones; ionomers and ionomeric precursors, acid copolymers, and conventional HNP type ionomers; polyurethanes; grafted and non-grafted metallocene-catalyzed polymers, such as single-site catalyst polymerized polymers, high crystalline acid polymers, cationic ionomers, and combinations thereof.

In one embodiment, the layer-forming material is a hard ionomer. By the term, “hard ionomer,” it is meant an ionomer having a hardness of about 60 to about 75 on the Shore D scale. Suitable hard ionomers may include, but are not limited to, ionic copolymers which are the sodium, zinc, magnesium or lithium salts of the reaction product of an olefin having from 2 to 8 carbon atoms and an unsaturated monocarboxylic acid having from 3 to 8 carbon atoms. The carboxylic acid groups of the copolymer may be totally or partially neutralized. Preferably, the hard ionomeric resins are copolymers of ethylene and either acrylic and/or methacrylic acid, with copolymers of ethylene and acrylic acid the most preferred. Examples of suitable commercially available ionomers resins include, but are not limited to, Surlyn® which is commercially available from E.I. du Pont de Nemours and Company, and Iotek® which is commercially available from Exxon Mobile Corporation.

Additives and fillers may be added to one or more layers of the golf ball. In one embodiment, the additives and/or fillers may be present in an amount of from 0 weight percent to about 50 weight percent, based on the total weight of the composition. In another embodiment, the additives and/or fillers may be present in an amount of from about 5 weight percent to about 30 weight percent, based on the total weight of the composition. In still another embodiment, the additives and/or fillers may be present in an amount of from about 10 weight percent to about 20 weight percent, based on the total weight of the composition.

Suitable additives and fillers include, but are not limited to, chemical blowing and foaming agents, optical brighteners, coloring agents, fluorescent agents, whitening agents, UV absorbers, light stabilizers, defoaming agents, processing aids, mica, talc, nano-fillers, antioxidants, stabilizers, softening agents, fragrance components, plasticizers, impact modifiers, TiO₂, acid copolymer wax, surfactants, and fillers, such as zinc oxide, tin oxide, barium sulfate, zinc sulfate, calcium oxide, calcium carbonate, zinc carbonate, barium carbonate, clay, tungsten, tungsten carbide, silica, lead silicate, regrind (recycled material), and mixtures thereof.

### Methods of the Present Invention

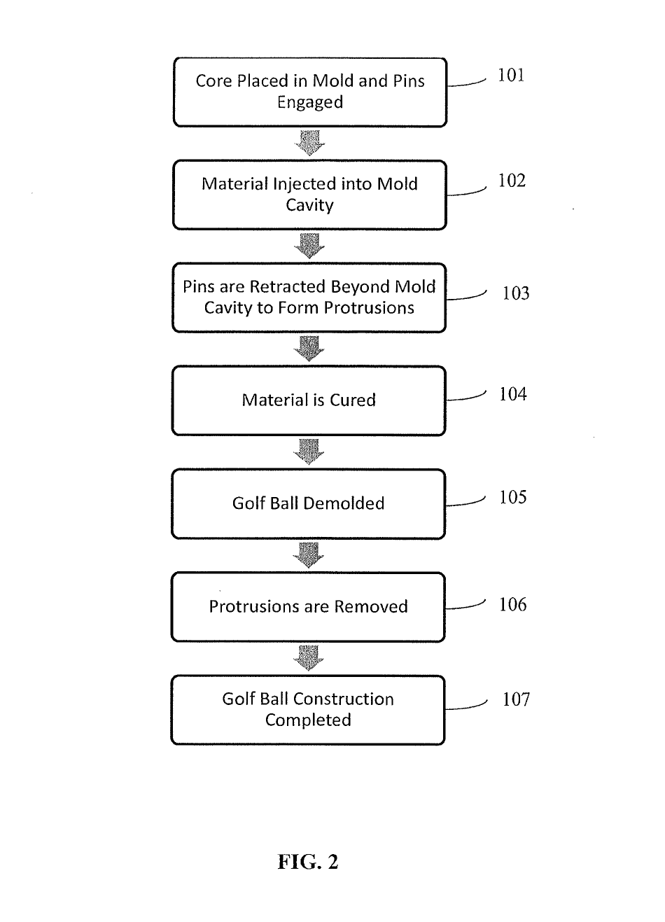

FIG. 2 illustrates one embodiment of a method contemplated by the present invention. At step 101, the inner ball 8 is placed inside the mold cavity 6 and the retractable pins 10 are engaged to securely hold the inner ball 8 in place. FIG. 1 shows the retractable pins 10 in the engaged position. As described above, the layer-forming material is loaded and stored in reservoirs or tanks 14. At step 102, once the inner ball 8 is in position such that the space between the outer surface of the inner ball 8 and the outer wall 7 is substantially consistent, the layer-forming material is injected into the mold cavity 6 surrounding the inner ball 8 via pathway 16. Upon injection, heat and pressure cause the material to flow into the space 18 between the core 8 and the outer wall 7 and thus form a layer of substantially constant thickness about the inner ball 8.

The pressure and temperature at which the layer-forming material is injected into the mold cavity 6 is dependent on the type of material used. For example, normal injection pressures for molding ionomers are typically in the range of about 5,000 psi to about 17,000 psi with machine barrel temperatures of about 350° F. to about 500° F. Mold temperatures are normally in the range of about 40° F. to about 125° F. The pins 10 hold the inner ball 8 in place while the injected layer-forming material fills the space 18 between the inner ball 8 and the outer wall 7 of the mold cavity 6.

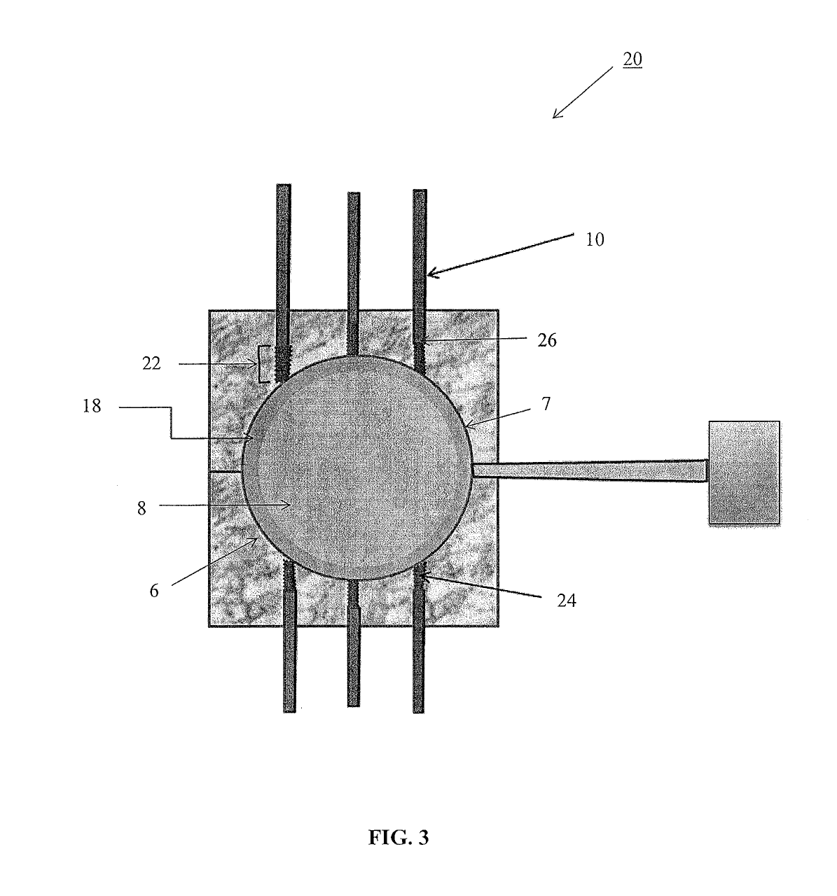

FIG. 3 illustrates a cross-sectional view of the RPIM mold after the injected layer-forming material fills the space 18 between the inner ball 8 and the outer wall 7 and the pins 10 are retracted. As the injected layer-forming material enters the space 18, a layer begins to form. Once the space 18 is nearly filled with layer-forming material, the pins 10 are retracted from the cavity 6 (step 103). The remainder of the space and the recesses created from the retracted pins is then filled completely with layer-forming material before the layer forming material has completely hardened.

As shown in FIG. 3, in one embodiment, the retractable pins 10 are withdrawn beyond the outer wall 7 of the mold cavity 6, leaving a space between the face of the pin 26 and the outer wall 7. When the pins 10 are retracted, the distance between the face of the pin 26 and the outer wall 7 is depicted in FIG. 3 as recess 22. The depth of recess 22 corresponds to the distance the pin 10 is retracted from the outer wall 7. In another embodiment, when two sets of retractable pins are used per mold plate, one set of retractable pins 10 supports the core 8 during injection and then retracts until the faces of the pins 26 are flush with the outer wall 7 of the mold cavity 6. In this aspect, another set of retractable pins 10 begins flush with the outer wall 7 of the mold cavity 6 and then retracts beyond the outer wall 7 forming recesses 22 as described above.

The amount of pin retraction may vary depending on the thickness of the layer formed about the inner ball 8. However, in one embodiment, the amount of pin retraction is at least 25 percent of the layer thickness, preferably at least 50 percent of the layer thickness, and most preferably at least 100 percent or more of the layer thickness. For example, the distance of retraction of pins 10 with respect to the mold cavity 6 is at least about 0.008 inches to about 0.090 inches. In another embodiment, the distance of retraction of pins 10 with respect to the mold cavity 6 is at least about 0.015 inches to about 0.080 inches. In still another embodiment, the distance of retraction of pins 10 with respect to the mold cavity 6 is at least about 0.025 inches to about 0.075 inches. In yet another embodiment, the distance of retraction of pins 10 with respect to the mold cavity 6 is at least about 0.040 inches to about 0.060 inches.

When the pins 10 are retracted beyond the outer wall 7, the trapped gases and the molten material that may have cooled prematurely due to contact with the pins escape into the recesses 22. Upon retraction of the pins 10, the layer-forming material fills into the area vacated by the retracted pins 10 in the mold cavity 6. When the layer-forming material fills into space 18 of the mold cavity 6, the layer-forming material essentially traps the gases and the material that may have cooled prematurely in the recesses 22 and forms protrusions 24 upon cooling (step 104). The cold material and trapped gases that normally cause stresses and defects in the formed cover or intermediate layers are confined to the protrusions 24.

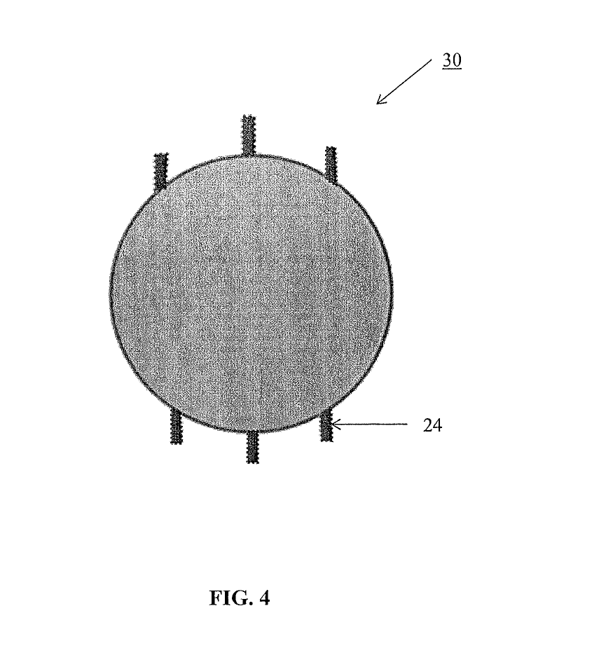

At step 105, after the injected layer-forming material has hardened, the mold 20 is opened and a provisional golf ball product 30 is removed. The golf ball is cooled in the mold 20 so it can be safely removed. As shown in FIG. 4, after the provisional golf ball product 30 is removed from the mold 20, the provisional golf ball 30 has a plurality of protrusions 24 at the locations where the pins 10 were retracted beyond the outer wall 7 of the mold cavity 6. In the case of two-piece balls, the protrusions 24 may be located in the area representing the land area after removal. By the term, “land area,” it is meant the upper flattened portion of the outermost cover layer extending from dimple to dimple.

The protrusions 24 are then removed from the provisional golf ball 30 in a post molding process (step 106). The protrusions 24 may be removed by any suitable method for removing flash or excess material from a layer of a golf ball known to one of ordinary skill in the art. Suitable methods include, but are not limited to, cutting, grinding, abrasion, centerless grinding, abrasive tumbling, sanding, heating, and combinations thereof.

After the protrusions 24 are removed from the provisional golf ball 30, a golf ball product is formed. In one embodiment, step 107 may indicate continued layer disposition if additional layers are contemplated. The present invention may be used with any type of ball construction including, but not limited to, one-piece, two-piece, three-piece, and four-piece designs, a double core, a double cover, an intermediate layer(s), a multilayer core, and/or a multi-layer cover depending on the type of performance desired of the ball. For example, in one embodiment, an intermediate layer formed by the above process may be centerless ground to remove the protruding material, and then followed by overmolding with one or more additional layers.

If the layer-forming material represents the outermost cover layer, step 107 may include post-finishing treatments such as painting, coating, or surface treating. For example, when the provisional golf ball product ultimately will receive a coating layer, a surface treatment of the outermost layer of the provisional golf ball 30 may be effected to improve adhesion between those layers. The surface treatment may include mechanical abrasion, e.g., sandblasting; plasma treatment, including treatment at atmospheric pressure; corona treatment; flame treatment; wet chemical surface modification; application of adhesives or adhesion promoters; and combinations thereof. Similarly, such surface treatments may be applied to the inner ball 8 prior to the injection molding process described herein.

Furthermore, golf balls may be coated with urethanes, urethane hybrids, ureas, urea hybrids, epoxies, polyesters, acrylics, or combinations thereof in order to obtain an extremely smooth, tack-free surface. If desired, more than one coating layer can be used. The coating layer(s) may be applied by any suitable method known to those of ordinary skill in the art.

### Golf Ball Construction

As discussed briefly above, the present invention may be used with any type of ball construction depending on the type of performance desired of the ball.

### Golf Ball Core Layer(s)

The core may have a diameter of about 1.0 inches to about 1.64 inches and the cover layer thickness may range from about 0.03 inches to about 0.06 inches. The core compression may be about 90 or less, or 80 or less, or 70 or less, or 60 or less, or 50 or less, or 40 or less, or 30 or less, or 20 or less, or a compression within a range having a lower limit of 10 or 20 or 30 or 35 or 40 and an upper limit of 50 or 60 or 70 or 80 or 90. In another embodiment, the core may have an overall compression of 40 or greater, or 50 or greater, or 60 or greater, or 70 or greater, or 80 or greater, or a compression within a range having a lower limit of 40 or 50 or 55 or 60 and an upper limit of 80.

The coefficient of restitution (“COR”) of a golf ball core made according to the invention may be at least about 0.750 at 125 ft/s. In one embodiment, the COR is at least about 0.775, at least about 0.780, at least about 0.782, at least about 0.785, at least about 0.787, at least about 0.790, at least about 0.795, at least about 0.798, or at least about 0.800.

Any core material known to one of ordinary skill in that art is suitable for use in the golf balls of the invention. In particular, the core may be solid, semi-solid, hollow, fluid-filled or powder-filled, one-piece or multi-component cores. As used herein, the term “fluid” includes a liquid, a paste, a gel, a gas, or any combination thereof; the term “fluid-filled” includes hollow centers or cores; and the term “semi-solid” refers to a paste, a gel, or the like. Suitable core materials include thermoset materials, such as rubber, styrene butadiene, polybutadiene, isoprene, polyisoprene, trans-isoprene, as well as thermoplastics such as ionomer resins, polyamides or polyesters, and thermoplastic and thermoset polyurethane elastomers.

### Golf Ball Intermediate Layer(s)

An intermediate layer, such as an outer core layer or inner cover layer, i.e., any layer(s) disposed between the inner core and the outer cover of a golf ball may be used in the present invention to form the inner ball. An intermediate layer may be used, if desired, with a multilayer cover or a multilayer core, or with both a multilayer cover and a multilayer core. As with the core, the intermediate layer may also include a plurality of layers.

An intermediate layer or inner cover layer of the present invention may have a thickness of about 0.015 inches to about 0.06 inches and may be disposed about a core. In this aspect of the invention, the core has a diameter ranging from about 1.5 inches to about 1.59 inches. The cover may have a thickness of about 0.02 inches to about 0.045 inches, preferably about 0.025 inches to about 0.04 inches.

In another embodiment, the intermediate layer is covered by an inner cover layer to form the inner ball. For example, an inner ball of the invention may include a center having a diameter of about 0.5 inches to about 1.30 inches. The center may be covered by an outer core layer to form a core. The outer core layer may have a thickness of about 0.125 inches to about 0.500 inches. The core may then be covered with a casing layer to form the inner ball having a thickness of about 0.015 inches to about 0.06 inches. The outer cover layer ultimately formed from the layer-forming material preferably has a thickness of about 0.02 inches to about 0.045 inches.

Such intermediate layer(s) may be formed, at least in part, from one or more homopolymeric or copolymeric materials, such as ionomers, primarily or fully non-ionomeric thermoplastic materials, vinyl resins, polyolefins, polyurethanes, polyureas, polyamides, acrylic resins and blends thereof, olefinic thermoplastic rubbers, block copolymers of styrene and butadiene, isoprene or ethylene-butylene rubber, copoly(ether-amide), polyphenylene oxide resins or blends thereof, and thermoplastic polyesters.

### Golf Ball Cover Layer(s)

The cover provides the interface between the ball and a club. Properties that are desirable for the cover are good moldability, high moisture resistance, high abrasion resistance, high impact resistance, high tear strength, high resilience, and good mold release, among others. The cover may be formed from one or more homopolymeric or copolymeric materials as discussed in the section above pertaining to the intermediate layer. Golf balls according to the invention may also be formed having a cover of polyurethane, polyurea, and polybutadiene materials.

In one embodiment, the cover may have a thickness of about 0.02 inches or greater. In another embodiment, the cover may be about 0.03 inches or greater in thickness. In still another embodiment, the thickness of the cover may range from about 0.02 inches to about 0.05 inches.

### Golf Ball Properties

Generally, golf ball layers using hard cover materials have less impact durability. For example, this is particularly true for golf ball constructions utilizing soft compression cores in combination with harder cover materials. These types of constructions are more sensitive to cover fracture durability problems because of the greater amount of ball deformation and cover flexing that occurs during impact.

However, the methods of the present invention help to improve the durability of golf balls, for example, the durability of golf ball constructions utilizing soft compression cores in combination with harder cover materials. Indeed, the golf balls produced according to the methods of the present invention have reduced molded stresses and defects and better impact durability.

### Component Dimensions

Dimensions of golf ball components, i.e., thickness and diameter, may vary depending on the desired properties. For the purposes of the invention, any layer thickness may be employed. For example, the present invention relates to golf balls of any size, although the golf ball preferably meets USGA standards of size and weight.

The preferred diameter of the golf balls is from about 1.680 inches to about 1.800 inches, more preferably from about 1.680 inches to about 1.760 inches. A diameter of from about 1.680 inches (43 mm) to about 1.740 inches (44 mm) is most preferred; however diameters anywhere in the range of from 1.700 to about 1.950 inches can be used.

Preferably, the overall diameter of the core and all intermediate layers is about 80 percent to about 98 percent of the overall diameter of the finished ball. The core may have a diameter ranging from about 0.09 inches to about 1.65 inches. In one embodiment, the diameter of the core of the present invention is about 1.2 inches to about 1.630 inches. For example, when part of a two-piece ball according to invention, the core may have a diameter ranging from about 1.5 inches to about 1.62 inches. In another embodiment, the diameter of the core is about 1.3 inches to about 1.6 inches, preferably from about 1.39 inches to about 1.6 inches, and more preferably from about 1.5 inches to about 1.6 inches. In yet another embodiment, the core has a diameter of about 1.55 inches to about 1.65 inches, preferably about 1.55 inches to about 1.60 inches.

If the core has multiple layers, such multi-layer cores of the present invention have an overall diameter within a range having a lower limit of about 1.0 or about 1.3 or about 1.4 or about 1.5 or about 1.6 or about 1.61 inches and an upper limit of about 1.62 inches or about 1.63 inches or about 1.64 inches. In a particular embodiment, the multi-layer core has an overall diameter of about 1.5 inches or about 1.51 inches or about 1.53 inches or about 1.55 inches or about 1.57 inches or about 1.58 inches or about 1.59 inches or about 1.6 inches or about 1.61 inches or about 1.62 inches.

The inner core has an overall diameter of about 0.5 inches or greater, or about 0.75 inches or greater, or about 0.8 inches or greater, or about 0.9 inches or greater, or about 1.0 inches or greater, or about 1.150 inches or greater, or about 1.25 inches or greater, or about 1.35 inches or greater, or about 1.39 inches or greater, or about 1.45 inches or greater, or an overall diameter within a range having a lower limit of about 0.25 or about 0.5 or about 0.75 or about 0.8 or about 0.9 or about 1.0 or about 1.1 or about 1.15 or about 1.2 inches and an upper limit of about 1.25 or about 1.3 or about 1.35 or about 1.39 or about 1.4 or about 1.44 or about 1.45 or about 1.46 or about 1.49 or about 1.5 or about 1.55 or about 1.58 or about 1.6 inches.

Each optional intermediate core layer may have an overall thickness within a range having a lower limit of about 0.005 inches to about 0.040 inches and an upper limit of about 0.05 inches to about 0.100 inches.

The cover typically has a thickness to provide sufficient strength, good performance characteristics, and durability. In one embodiment, the cover thickness is from about 0.02 inches to about 0.12 inches, preferably about 0.1 inches or less. For example, when part of a two-piece ball according to invention, the cover may have a thickness ranging from about 0.03 inches to about 0.09 inches. In another embodiment, the cover thickness is about 0.05 inches or less, preferably from about 0.02 inches to about 0.05 inches, and more preferably about 0.02 inches and about 0.045 inches.

The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the present invention, the intermediate layer, or inner cover layer, may have a thickness about 0.3 inches or less. In one embodiment, the thickness of the intermediate layer is from about 0.002 inches to about 0.1 inches, and preferably about 0.01 inches or greater. For example, when part of a three-piece ball or multi-layer ball according to the invention, the intermediate layer and/or inner cover layer may have a thickness ranging from about 0.015 inches to about 0.06 inches. In another embodiment, the intermediate layer thickness is about 0.05 inches or less, more preferably about 0.01 inches to about 0.045 inches.

### Hardness

The cores included in the golf balls of the present invention may have varying hardnesses depending on the particular golf ball construction. In one embodiment, the core hardness ranges from about 50 Shore C to about 65 Shore C. In another embodiment, the core has a hardness ranging from about 50 Shore C to about 85 Shore C.

The intermediate layers of the present invention may also vary in hardness depending on the specific construction of the ball. In one embodiment, the surface hardness of the intermediate layer may be about 75 Shore D or less, or about 65 Shore D or less. In another embodiment, the surface hardness of the intermediate layer may be about 50 to about 65 Shore D, preferably about 55 to about 60 Shore D.

As with the core and intermediate layers, the cover hardness may vary depending on the construction and desired characteristics of the golf ball. In one embodiment, the cover may have a surface hardness of about 60 Shore D or less and/or a material hardness of about 60 Shore D or less. In another embodiment, the cover is a dual- or multi-layer cover including an inner or intermediate cover layer and an outer cover layer formed. The inner layer may have a surface hardness of about 75 Shore D or less, or about 65 Shore D or less, or about 60 Shore D or less. The outer cover layer may have a surface hardness ranging from about 20 Shore D to about 75 Shore D.

### Compression

Compression is an important factor in golf ball design. For example, the compression of the core can affect the ball's spin rate off the driver and the feel. In fact, the compositions and methods of the present invention result in golf balls having increased compressions and ultimately an overall harder ball. The harder the overall ball, the less deformed it becomes upon striking, and the faster it breaks away from the golf club.

As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, “compression” refers to Atti compression and is measured according to a known procedure, using an Atti compression test device, wherein a piston is used to compress a ball against a spring.

Golf balls of the present invention typically have a compression of 40 or greater, or a compression within a range having a lower limit of 50 or 60 and an upper limit of 100 or 120.

### Coefficient of Restitution

The coefficient of restitution or COR of a golf ball is a measure of the amount of energy lost when two objects collide. The COR of a golf ball indicates its ability to rebound and accounts for the spring-like feel of the ball after striking. As used herein, the term “coefficient of restitution” (COR) is calculated by dividing the rebound velocity of the golf ball by the incoming velocity when a golf ball is shot out of an air cannon. The COR testing is conducted over a range of incoming velocities and determined at an inbound velocity of 125 ft/s.

In this aspect, the present invention contemplates golf balls having CORs from about 0.700 to about 0.850 at an inbound velocity of about 125 ft/sec. In one embodiment, the COR is about 0.750 or greater, preferably about 0.780 or greater. In another embodiment, the ball has a COR of about 0.800 or greater. In yet another embodiment, the COR of the balls of the invention is about 0.800 to about 0.815.

Solid spheres (1.55 inches) formed of the compositions of the invention may have a COR of at least about 0.790, preferably at least about 0.800. For example, the COR of solid spheres formed from the compositions of the invention ranges from about 0.810 to about 0.830. In one embodiment, a solid sphere formed from the composition of the invention has a COR of about 0.800 to about 0.825. In another embodiment, the COR of the solid sphere ranges from about 0.805 to about 0.815.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended as illustrations of several aspects of the invention. Any equivalent embodiments are intended to be within the scope of this invention. For example, the present invention may also be used in accordance with reaction injection molding processes. Indeed, various modifications of the invention in addition to those shown and described herein will become apparent to those skilled in the art from the foregoing description. Such modifications are also intended to fall within the scope of the appended claims. All patents and patent applications cited in the foregoing text are expressly incorporate herein by reference in their entirety.

What is claimed is:

1. A method of forming a golf ball, comprising:
providing a mold cavity comprising a first mold half having a first cavity half defining a first hemispherical portion having a first wall and a second mold half comprising a second cavity half defining a second hemispherical portion having a second wall;
placing an inner ball having an outer surface into the first mold half;
extending retractable pins into the first mold half to retain the inner ball within the first mold half;
mating the second mold half to the first mold half;
extending retractable pins into the second mold half, wherein the distance from the outer surface to the first wall is substantially the same as the distance from the outer surface to the second wall;
injecting a material into the mold cavity to form a layer disposed about the inner ball;
withdrawing the retractable pins beyond the first and second walls to allow the material to flow into recesses formed between the withdrawn pins and the first and second walls and form protrusions at each of the recesses;
cooling the material; and
removing the protrusions to form a golf ball.

2. The method of claim 1, wherein the first and second mold halves each comprises at least three retractable pins.

3. The method of claim 1, wherein the step of removing the protrusions comprises cutting, grinding, abrasion, centerless grinding, abrasive tumbling, sanding, heating, or combinations thereof.

4. The method of claim 1, wherein the material comprises an ionomer having a hardness of about 60 to about 75 Shore D.

5. The method of claim 1, wherein the material comprises an ionomer, a polyamide, a polyurethane, a polyurea, or combinations thereof.

6. The method of claim 1, wherein the retractable pins are withdrawn a distance of at least about 25 percent of the thickness of the golf ball layer.

7. A method of forming a golf ball, comprising:
providing a mold comprising an upper mold plate, a lower mold plate, wherein the upper and lower mold plate each comprise at least three retractable pins, and wherein the upper and lower mold plates mate to form a mold cavity having a substantially spherical cavity wall;
placing an inner ball into the mold cavity;
extending the at least three retractable pins into the mold cavity in each of the upper and lower mold plates to hold the inner ball within the mold cavity, wherein the retractable pins produce a space between the cavity wall and the outer surface of the inner ball;
injecting a material into the mold cavity to form a golf ball layer disposed about the inner ball;
withdrawing the retractable pins beyond the cavity wall a predetermined distance to allow the material to flow into recesses formed between the withdrawn pins and the cavity wall and form protrusions at each of the recesses;
cooling the material to form a provisional golf ball having a plurality of protrusions;
de-molding the provisional golf ball; and
removing the protrusions to form a golf ball.

8. The method of claim 7, wherein the step of removing the protrusions further comprises cutting, grinding, abrasion, centerless grinding, abrasive tumbling, sanding, heating, and combinations thereof.

9. The method of claim 7, wherein the step of withdrawing the retractable pins comprises withdrawing the retractable pins a predetermined distance that is at least about 25 percent of the thickness of the golf ball layer.

10. The method of claim 7, further comprising surface treating the golf ball.

11. The method of claim 10, wherein the step of surface treating comprises mechanical abrasion; plasma treatment; corona treatment; flame treatment; wet chemical surface modification; application of adhesives or adhesion promoters; and combinations thereof.

12. A method for injection molding a golf ball layer about an inner ball, comprising:
providing a mold comprising an upper mold plate and a lower mold plate, wherein the upper and lower mold plates each comprise at least three retractable pins for holding the inner ball within a cavity formed by mating the upper and lower mold plates, wherein the cavity has a substantially spherical surface;
placing the inner ball into the mold, wherein the inner ball has an outer surface;
extending the retractable pins into the cavity to form a space between the cavity surface and the outer surface of the inner ball;
injecting a layer-forming material into the cavity to fill the space and form a golf ball layer disposed about the inner ball;
withdrawing the retractable pins beyond the cavity surface a distance of at least about 25 percent of the thickness of the golf ball layer to allow the material to flow into recesses formed between the withdrawn pins and the cavity surface and form protrusions at each of the recesses;
cooling the layer-forming material to form a provisional golf ball having a plurality of protrusions;
de-molding the provisional golf ball; and
removing the protrusions to form a golf ball.

13. The method of claim 12, wherein the step of withdrawing the retractable pins is performed at a distance at least 50 percent of the thickness of the golf ball layer.

14. The method of claim 13, wherein the distance is at least 100 percent of the thickness of the golf ball layer.

15. The method of claim 12, wherein the step of removing the protrusions further comprises cutting, grinding, abrasion, centerless grinding, abrasive tumbling, sanding, heating, and combinations thereof.

16. The method of claim 12, further comprising molding one or more additional layers over the golf ball.
